(19) United States
(12) Patent Application Publication
(10) Pub. No.: US 2017/0124899 A1
(43) Pub. Date: May 4, 2017

(54) ELECTRONIC EDUCATIONAL SYSTEM

(71) Applicant: Inna Nurik, Brooklyn, NY (US)

(72) Inventor: Inna Nurik, Brooklyn, NY (US)

(21) Appl. No.: 14/929,296

(22) Filed: Oct. 31, 2015

(51) Int. Cl. G09B 19/00; H04W 4/00; H04L 29/12; G09B 5/02; H04W 12/06

(52) U.S. Cl. CPC G09B 19/00; G09B 5/02; H04W 12/06; H04L 61/6081; H04W 4/008; H04W 88/08

(57) ABSTRACT

Disclosed is a system for tracking student progress within an educational environment. A system comprising one or more base-stations and a plurality of remote units. Each base-station having a wireless communications module which allows for two directional communication with the remote units. Each base-station further comprising a general purpose computer connector which allows interfacing with a general purpose computer. Each remote unit having a wireless communications module which is compatible with the wireless communications module within the base-station. Each remote unit has an input module, which collects information from a user, and a display module. The system further comprises a student tracking module, which comprises an attendance module, a challenge response module, and a student identification module. The system allows for granular tracking of student progress, tracking of curriculum pacing, identifies areas for curriculum modifications according to students' needs, provides systemic tracking of learning and teaching to educational administrators.

### BACKGROUND

Student progress is one of the core benchmarks of education. Educators must track not only the end point but the starting point of a student in order to be able to gauge performance, progress, and success. As class sizes rise is becomes more and more difficult for the education system to deal with the ever increasing demands of the learning environment. Increased demands from parents, governmental bodies, and from the educational institutions themselves have increased pressure on educators. With increased demands on educators it has become more important than ever to track individual student progress. It is only recently that educators have begun tracking individual student interaction. Current methods to track student information involve significant amounts of time, are cumbersome, lack granularity, lack specificity, or are incapable of progress tracking. Information relevant to attempts to address these problems can be found in U.S. Patent Nos. US20100185957, US20120159331, US20130164725, and US20120164619. However, each one of these references suffers from one or more of the following disadvantages: delayed analysis, limited scope, generalizations that do not address and reflect immediate student's needs, and/or limited utility.

For the foregoing reasons, there is a need for a more comprehensive system to track real-time and near real-time student progress and to monitor student responses.

### SUMMARY

The present invention is directed to a system for tracking individual student progress, group progress, as well as depth of teacher's preparations, curriculum pacing, and leadership support within an educational environment. A system comprising one or more base-stations and a plurality of remote units. Each base-station having a wireless communications module which allows for two directional communication with the remote units. Each base-station further comprising a connector which allows interfacing with a general purpose computer. Each remote unit having a wireless communications module which is compatible with the wireless communications module within the base-station. Each remote unit has an input module which collects information from a user. Each remote unit further comprises a display module. The system further comprises a student tracking module. Said student tracking module comprises an attendance module, a challenge response module, and a student identification module.

An embodiment of the system wherein the base-station further comprises a screen which allows for the system to be used without a general purpose computer.

Another embodiment of the system wherein the identification module further comprises a hardware token which allows identification of an individual student.

Another embodiment of the system wherein the connector is a USB connector.

Another embodiment of the system wherein the wireless communications modules are based on WiFi technology.

Another embodiment of the system wherein the wireless communications modules are based on Bluetooth technology.

Another embodiment of the system wherein the wireless communications modules are based on ZigBee technology.

### BRIEF DESCRIPTION OF DRAWINGS

The accompanying drawings, which are incorporated in and constitute a part of the specification, illustrate a presently preferred embodiment and a presently preferred method of the invention. These drawings, together with the general description given above and the detailed description of the preferred embodiment and method given below, serve to explain the principles of the invention.

FIG. 1 shows a flowchart of a usage case of an embodiment of the invention;

FIG. 2A shows a block diagram of an embodiment of the invention communication system;

FIG. 2B shows a block diagram of an alternative embodiment of the invention communication system;

FIG. 3 shows a block diagram of an embodiment of the base station control;

FIG. 4 shows a block diagram of an embodiment of the remote unit;

FIG. 5 shows a block diagram of an embodiment of the base station student tracking module;

FIG. 6 shows a block diagram of an embodiment of the base station student tracking module communication with an eternal computing device;

FIG. 7A shows an example of an embodiment of the user interface of the remote unit user identification entry;

FIG. 7B shows an example of an embodiment of the user interface of the remote unit question prompt;

FIG. 7C shows an example of an embodiment of the user interface of the remote unit rating prompt;

FIG. 7D shows an example of an embodiment of the user interface of the remote unit rating prompt;

FIG. 7E shows an example of an embodiment of the user interface of the remote unit feedback prompt;

FIG. 8A shows an example of an embodiment of the user interface of the base station student tracking module overview;

FIG. 8B shows an example of an embodiment of the user interface of the base station student tracking module overview;

FIG. 8C shows an example of an embodiment of the user interface of the base station student tracking module individual student display;

FIG. 8D shows an example of an embodiment of the user interface of the base station student tracking module recommendations;

FIG. 9 shows a block diagram of an embodiment of challenge response timing tracking;

### DESCRIPTION

In the Summary above and in the Description, and the claims below, and in the accompanying drawings, reference is made to particular features [including method steps] of the invention. It is so understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps (except where the context excludes that possibility).

The term “at least” followed by a number is used herein to denote the start of a range beginning with that number (which may be a range having an upper limit or no upper limit, depending on the variable being defined). For example “at least 1” means one or more than one. The term “at most” followed by a number is used herein to denote the end of a range ending with that number (which may be a range having 1 or 0 as its lower limit, or a range having no lower limit, depending upon the variable then being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm

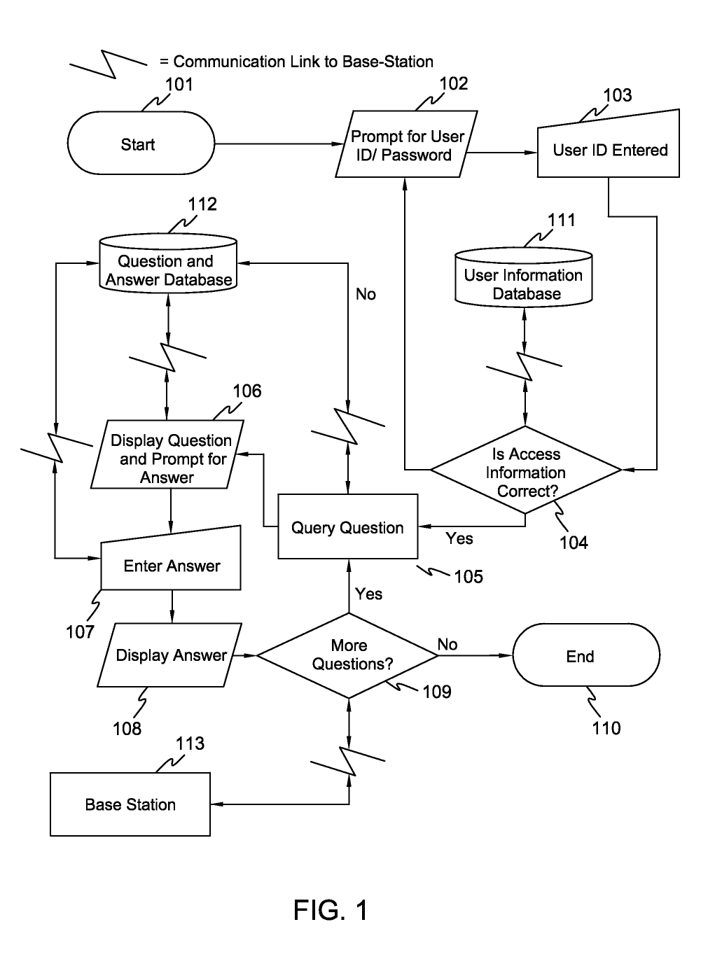

As shown in FIG. 1, a flowchart of a usage case of an embodiment of the invention, the process of using the specified embodiment a system of the invention begins with the Beginning of Process 101 portion of the flowchart. A user is prompted to for information which will uniquely identify said user, a User ID, at the User Prompt 102. Entry Of User ID 103 is effectuated by said user. Upon entry of said User ID, the system proceeds to Analyze User ID 104, if the User ID is rejected the User Prompt 102 may be provided again depending on the configuration of the system. Upon the successful completion of the step to Analyze User ID 104, request is made in the form of a Question Query 105. Said Question Query 105 returns the information which is necessary to provide a Question Display And Answer Prompt 106. Said user enters an answer to said Question Display And Answer Prompt 106 via an Answer Entry 107. Upon completion of the Answer Entry 107, the system proceeds to an Answer Display 108 wherein a correct response to said Question Query 105 is displayed. Upon completion of the Answer Display 108, the system provides a Prompt For More Questions 109. The Base Station 113 send a communication in response to a Prompt For More Questions 109 the process reverts to a Question Query 105, said Base Station 113 communicates a directive to continue, in the event that the Base Station 113 communicates a directive to stop, the process reaches an End Of Process 110 condition where the system stops any more Question Query 105 steps. Said User ID and any other uniquely identifying information is sent to a User Information Database 111 in order to determine if the user is authorized to continue and in order to track any Answer Entry 107 from said user. The Question Query 105, the Question Display and Answer Prompt 106, the Answer Entry 107, and the Answer Display 108 interact with a Question Answer Database 112 which provides questions and the respective answers.

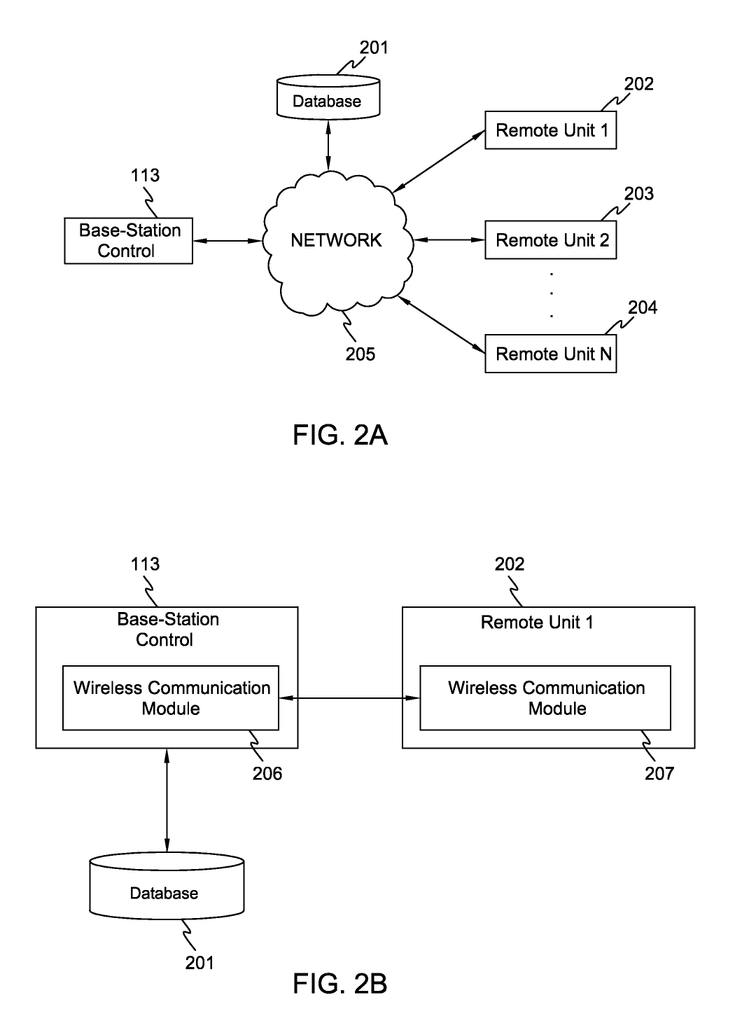

As shown in FIG. 2, a block diagram of an embodiment of the invention communication system, said Base Station 113 communicates with a plurality of remote units, Remote Unit 1 202, Remote Unit 2 203, Remote Unit 3 204, through a General Purpose Network 205. In addition, said Base Station 113 communicates through said General Purpose Network 205 to an External Database 201 which may contain any of the information which is required by an embodiment of the invention. The External Database 201 may contain user information, attendance information, question and answer information, or any other information which is utilized by the various embodiments of the present invention.

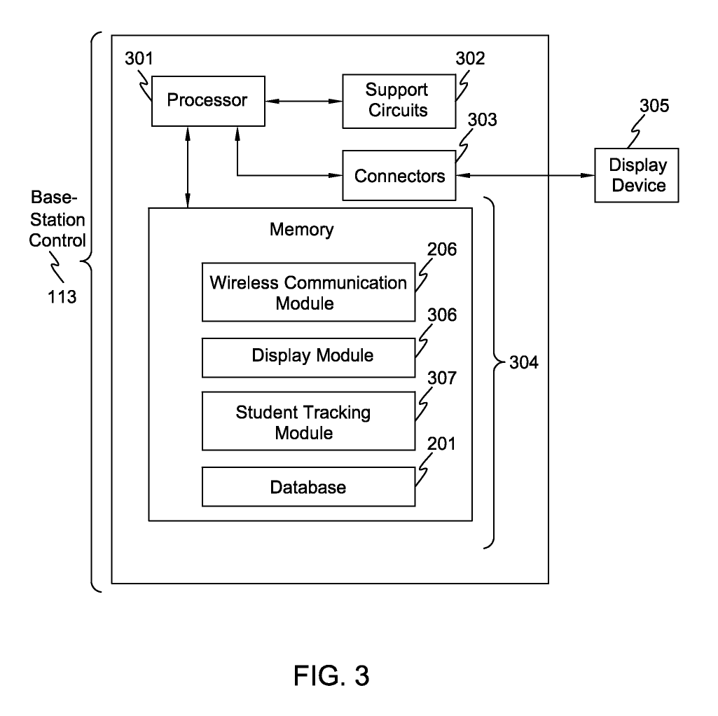

As shown in FIG. 3, a block diagram of an embodiment of the Base Station 113, includes processor 301. The Processor 301 is connected to Support Circuits 302, General Purpose Connectors 303, and a Memory Storage System 304. The Memory Storage System 304 contains a Base Station Wireless Communications Module 206, a Display Module 306, a Base Station Student Tracking Module 307, and an External Database 201.

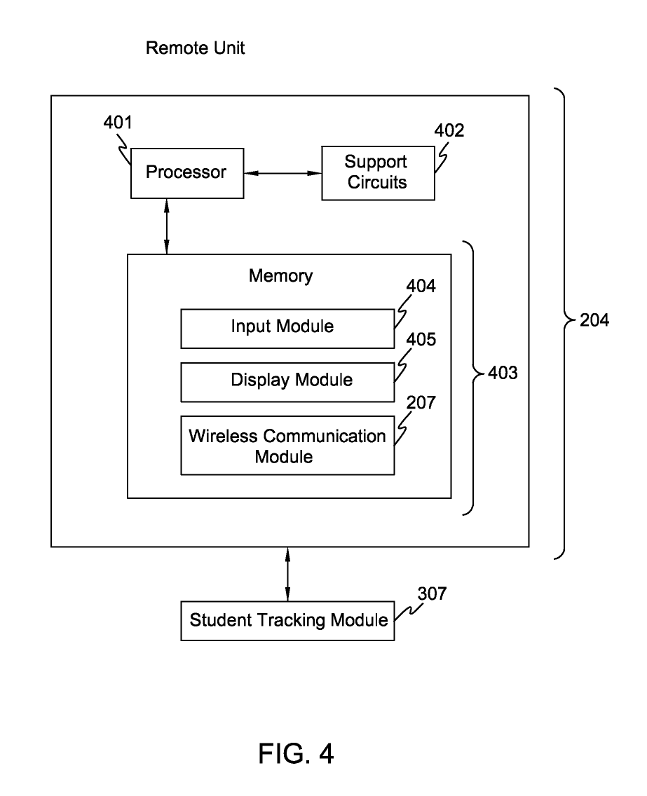

As shown in FIG. 4, a block diagram of an embodiment of the Remote Unit 204 which includes a Remote Unit General Purpose Central Processing Unit 401, the Remote Unit General Purpose Central Processing Unit 401 is electronically connected to Remote Unit Support Circuits 402. The Remote Unit General Purpose Central Processing Unit 401 is electronically connected to Remote Unit Memory 403 which contains Remote Unit Input Module 404, Remote Unit Display Module 405, and Remote Unit Wireless Communication Module 207. The Remote Unit 3 204 is connected electronically to Base Station Student Tracking Module 307.

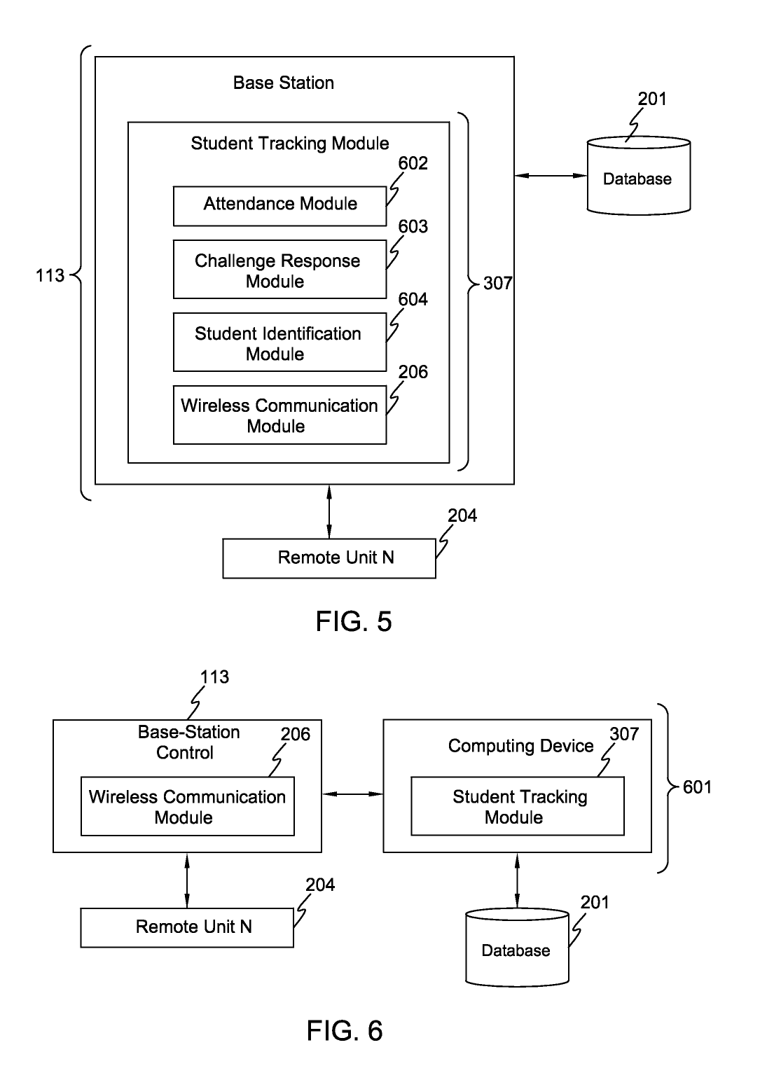

As shown in FIG. 5, a block diagram of an embodiment of the base station student tracking module includes a Base Station 113. The Base Station 113 contains a Base Station Student Tracking Module 307. The Base Station Student Tracking Module 307 contains a Base Station Attendance Module 602, a Base Station Challenge Response Module 603, a Base Station Student Identification Module 604, and a base Station Wireless Communications Module 206. The base Station 113 is electrically connected to an external Database 201. The base Station 113 is further wireless connected to a remote Unit 204.

As shown in FIG. 6, a block diagram of an embodiment of the base station student tracking module communication with an eternal computing device, a base Station 113 contacts a base Station Wireless Communications Module 206 which is wirelessly connected to a remote Unit 204. The base Station 113 is further connected to an external computing device 601, which contains a base Station Student Tracking Module 307. The base Station 113 is connected to an external Database 201.

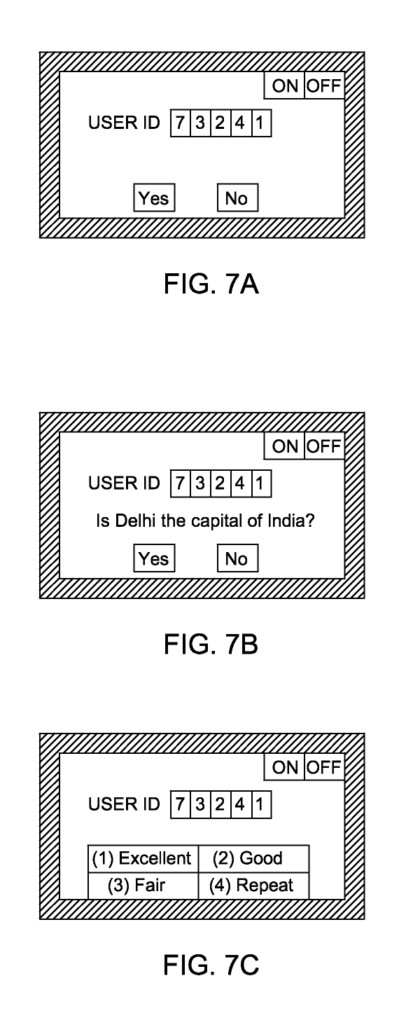

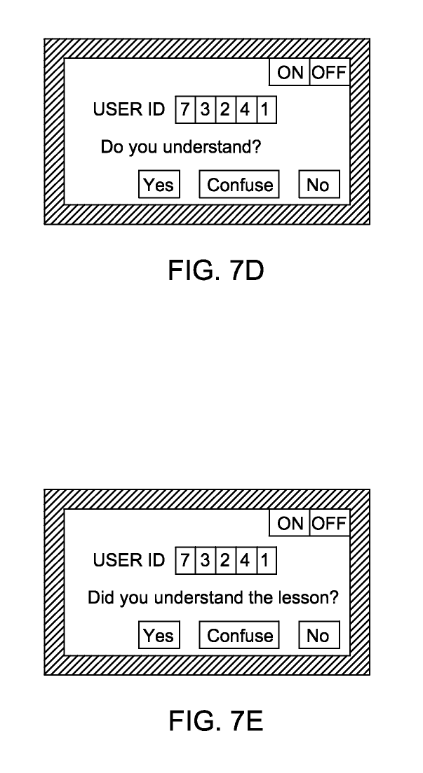

As shown in FIG. 7A an example of an embodiment of the user interface of the remote unit user identification entry, a unique user identification number can be used to connect to the system.

As shown in FIG. 7B an example of an embodiment of the user interface of the remote unit question prompt, a user is prompted with questions and can provide answers.

As shown in FIG. 7C an example of an embodiment of the user interface of the remote unit rating prompt, a rating can be exchanged between the remote unit and the base station to track student success.

As shown in FIG. 7D an example of an embodiment of the user interface of the remote unit rating prompt, a user can be prompted to gauge whether the user understands a question which was presented.

As shown in FIG. 7E an example of an embodiment of the user interface of the remote unit feedback prompt, a user can be prompted to gauge whether the user understands a lesson which was presented.

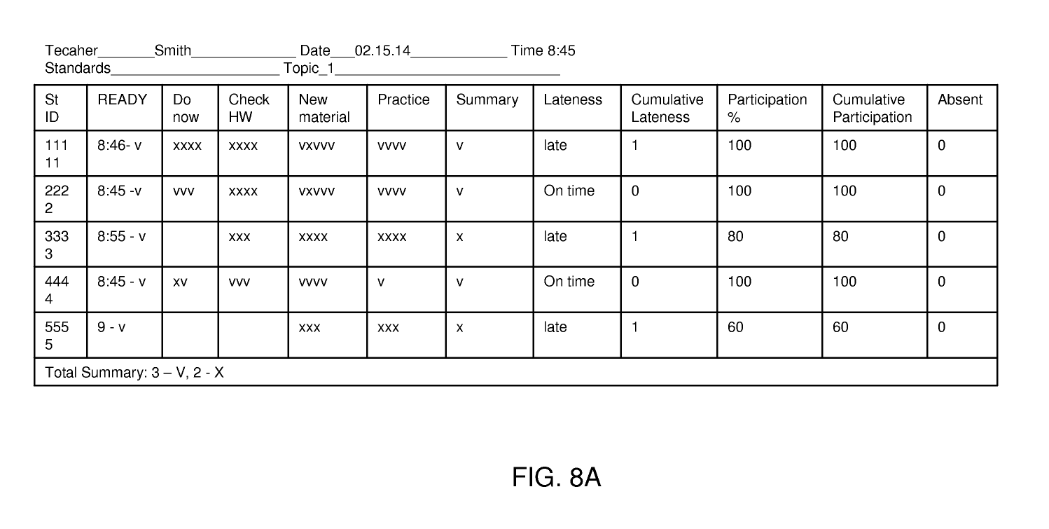

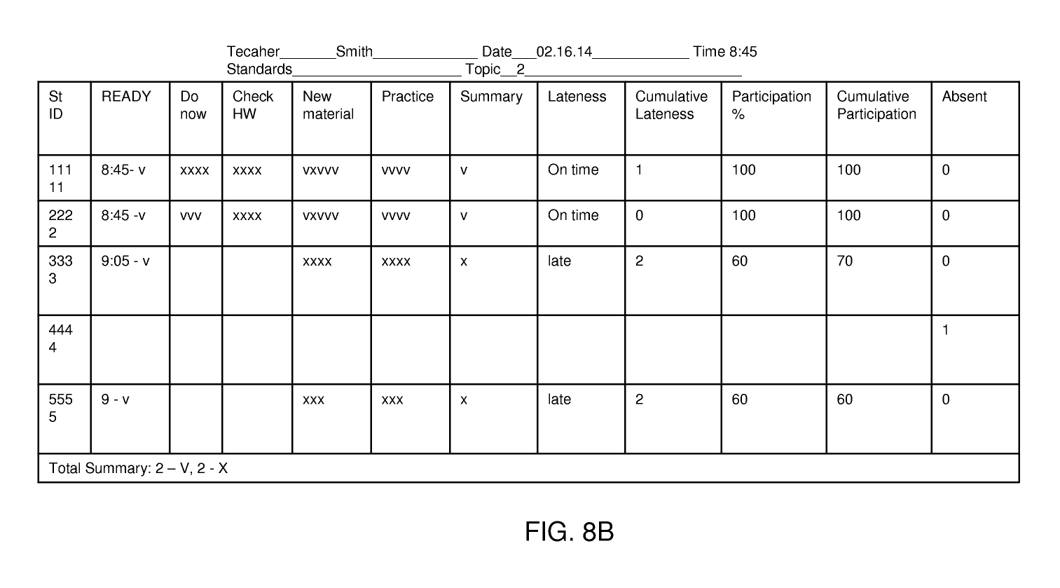

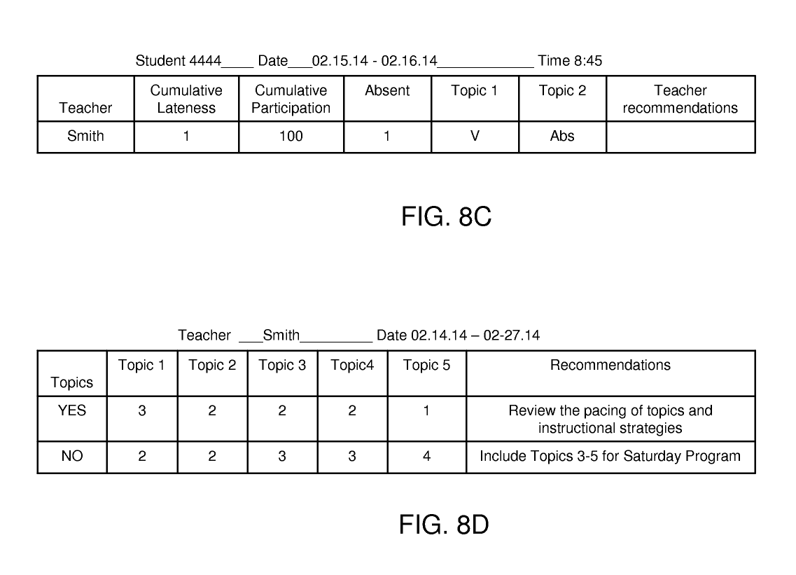

As shown in FIG. 8A an example of an embodiment of the user interface of the base station student tracking module overview, the user interface shows various characteristics which can be tracked a user for a given topic.

As shown in FIG. 8B an example of an embodiment of the user interface of the base station student tracking module overview, the user interface shows various characteristics which can be tracked a user for an alternative topic.

As shown in FIG. 8C an example of an embodiment of the user interface of the base station student tracking module individual student display, which shows individual user information.

As shown in FIG. 8D an example of an embodiment of the user interface of the base station student tracking module recommendations, this interface includes recommendations for future lessons or studying for a given user.

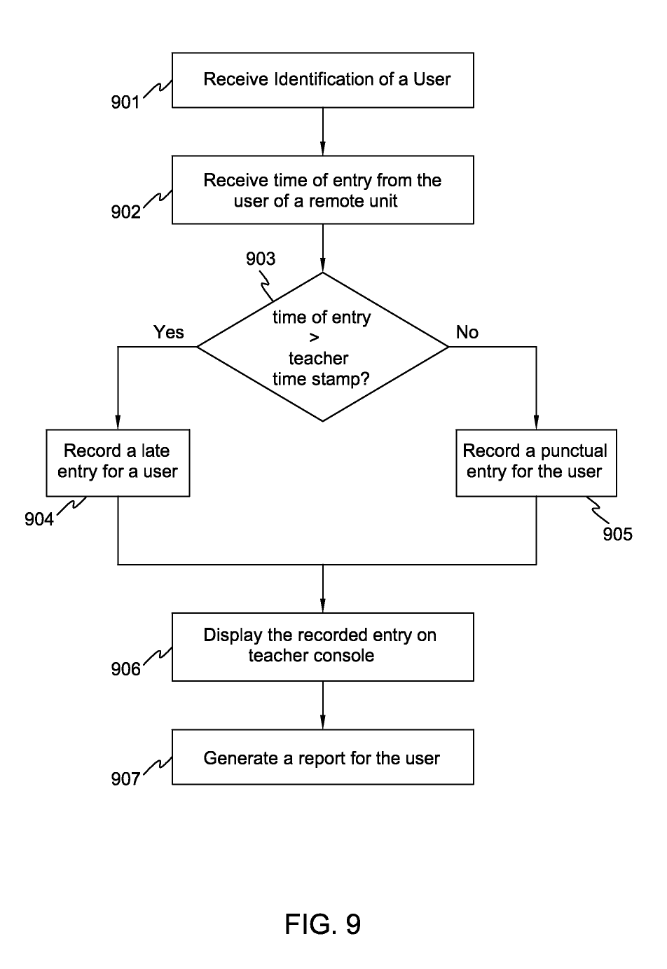

As shown in FIG. 9 a block diagram of an embodiment of challenge response timing tracking, upon Receipt Of User Identification 901 from a Remote Unit User to a Base Station, the Base Station is sent and commences receipt of an Entry and Entry Time 902. The Entry Time 902 is run through an Evaluation of Time of Entry 903. The Evaluation of Time of Entry 903 determines if the Entry time 902 is before the question completion time given by a Base Station User. If the Entry Time 902 is after the completion time a Receipt Of Entry Time 902 event is recorded, otherwise a Punctual Entry Received 905 is recorded. The Base Station Display Of Results 906 then occurs followed by a report. The final step follows where the Report is Displayed to the User 907.

A system which can be used to track student information, comprising: one or more base-stations, a plurality of remote units, each base-station having a wireless communications module, each base-station further comprising a general purpose computer connector which allows interfacing with a general purpose computer, each remote unit having a wireless communications module which is compatible with the wireless communications module contained within the base-station, each remote unit has an input module which collects information from a user, each remote unit further comprises a display module, the system further comprises a student tracking module, said student tracking module comprises an attendance monitor, a challenge response module, and a student identification tracking module.

The general purpose computer connector contained within each base-station is used to interface with a general purpose computing system. The general purpose computing system provides software which can be used to track student progress, track student attendance, curriculum and its pacing, and can be used to identify students using uniquely keyed information. The general purpose computer connector can be any type which allows for this type of interface such as USB, Serial, Firewire, or any other connector which serves a similar purpose.

The wireless communications module within the remote units and base-station can be of any complimentary type. Depending on the embodiment of this communications module, it can allow for interfacing between the units and also between the base-station and a general purpose computer. The communications module can be based on any wireless technology, including but not limited to: WiFi, Bluetooth, ZigBee, or any other general purpose wireless technology. Depending on the wireless communication technology chosen, some embodiments of the invention allow for mesh networking between the remote units and/or the base-stations.

The input module within each remote unit allows for users to enter identification information, answer questions, or to respond to any number of queries from the base-station or the remote unit itself The input module can be as simple as a few buttons but can also be more complex, incorporating other technologies for user input.

The display module within each remote unit serves to provide users with feedback with respect to any information inputted. The display module can be any display technology, the simplest of which is an indicator light, but can utilize liquid crystal display, or other display technologies. The display modules main purpose is to give a user the information necessary to interact with the system.

An embodiment of the student tracking module can be contained either within a base-station or within a general purpose computer which is connected to a base-station. The student tracking module allows for tracking student learning progress within a challenge response module, by logging student responses to questions, each piece of student information is stored as a tracking metric. The challenge response module identifies each student by some unique identifier and can be used to calculate student progression as well as to compare individual student progress with progress of a group of students. By giving the educator granular control over each tracking metric the desired comparisons can be made individually, within a group, within a classroom, within a grade, within a school, or even nationwide. The student tracking module further comprises a student identification module, the student identification module utilizes a database of student information to identify individual students, track their learning progress and performance levels, and determine which students are using individual remote units which determines each student's lesson participation. The student tracking module also has an attendance module which stores information on the exact dates and time where a student was present. The attendance module can work in conjunction with the challenge response module to determine whether a student may have been tardy for a specific lesson. An embodiment of the student tracking module can use information from within the attendance module, challenge response module, and the identification module to determine, among other things which classes the student was present, student progress and position within both subjects and individual areas of specific subjects. By utilizing this information it could be possible to determine, for example, whether a student lacks knowledge of a topic due to an absence or another reason, set student learning goals, pacing and sequencing of delivered curriculum, areas for teachers' professional learning, and leadership support.

In order to utilize the invention, a supervising user will set up student information. The users as a group or individually can answer instructor's questions which are not preset and vary depending on students' learning of presented material in real-time environment. In order to answer instructor's questions/participate in a lesson a user of a remote unit, a student enters or otherwise provides identifying information for that student. The information can be in the form of a unique hardware token assigned to the student, or can be in the form of identification entered directly on the remote unit. Once a user has entered or otherwise provided this identifying information the base-station confirms whether or not the user should be granted access based on the information provided. The base-station is controlled by a supervisor, the supervisor is responsible for assigning questions if no automated assignment of questions has been chosen. The supervisor can assign questions from a predetermined lesson plan, these questions can be assigned to all users, a single user, or any defined group of user. The supervisor can set the questions to one of several modes of answer, a mode where each user in the determined group is given the opportunity to enter a response on the individual remote unit which said user is assigned or in a mode where the first entry by any user in a chosen group is the only response registered. Response times along with the adequacy of responses is collected by the base-station. The responses are sent via a wireless communications module contained within each remote unit to a complimentary wireless communication module contained within a base-station. The base-station stores the responses in a database and if and when instructed provides the summary of learning and teaching for each section of a lesson, for the whole lesson, end of a unit, marking period, and an academic year. The database can be used to track information within groups of differing size. If for instance the user is a student within a class, the class information, student information, instructor information, and any other definable group can be shown by the base-station. The database can be used to determine future curriculums, provide professional development for instructors, determine necessity and progression of academic intervention programs, and to provide leadership support where necessary.

The previously described embodiments of the present invention have many advantages, including the ability track individual student progress, the ability to monitor student participation, and the ability to reduce required manual tracking. This system also permits to address educators' core-subject and pedagogical knowledge and skills.

The invention does not require that all of the advantageous features and all the advantages need to be incorporated into every embodiment of the invention.

### Embodiments of the Present Invention

Although the present invention has been described in considerable detail with reference to certain preferred versions thereof, other versions are possible. For example the general purpose computer connector shown is a USB connector but the connector could easily be any general purpose electronics connector, or the display shown is a liquid crystal display, could be any display type or technology. Therefore, the spirit and scope of the appended claims should not be limited to the description of the preferred versions contained herein.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features service the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of in the claims herein is not intended to invoke the provisions of 35 U.S.C. §112, ¶6.

What is claimed is:

1. An educational system, comprising:
a) one or more base stations, each having a base station wireless communications module and a general purpose computer connector;
b) a plurality of remote units, each having a remote unit wireless communications module; and,
c) a student tracking module, said student tracking module containing an attendance module, a challenge response module; and a student identification module.

2. The educational system of claim 1 wherein said base stations further comprise a general purpose processor, said general purpose processor is electrically connected with a general purpose connector to a display device, said general purpose processor is further electrically connected a memory device.

3. The educational system of claim 2 wherein said base stations further comprise a database which is contained within said memory device, said memory device further contains a general purpose database and said student tracking module is contained within said memory device.

4. The educational system of claim 1 wherein said student tracking module further comprises an external database which stores information necessary for said attendance module, said challenge response module, and said student identification module.

5. The educational system of claim 2 wherein said student tracking module further comprises an external database which stores information necessary for said attendance module, said challenge response module, and said student identification module.

6. The educational system of claim 3 wherein said student tracking module further comprises an external database which stores information necessary for said attendance module, said challenge response module, and said student identification module.

7. The educational system of claim 1 wherein said student tracking module further comprises an external database which stores information necessary for said attendance module, said challenge response module, and said student identification module.

8. The educational system of claim 2 wherein said student tracking module further comprises an external database which stores information necessary for said attendance module, said challenge response module, and said student identification module.

9. The educational system of claim 1 wherein said remote units further comprise a general purpose processor, said general purpose processor is electrically connected to a memory device, said memory device is electrically connected to an input module, and a display module.

10. The educational system of claim 2 wherein said remote units further comprise a general purpose processor, said general purpose processor is electrically connected to a memory device, said memory device is electrically connected to an input module, and a display module.

11. The educational system of claim 1 wherein said educational system further comprises a reporting structure that allows for information to tracked and analyzed.

12. The educational system of claim 2 wherein said educational system further comprises a reporting structure that allows for information to tracked and analyzed.

13. The educational system of claim 3 wherein said educational system further comprises a reporting structure that allows for information to tracked and analyzed.

14. The educational system of claim 4 wherein said educational system further comprises a reporting structure that allows for information to tracked and analyzed.

15. The educational system of claim 5 wherein said educational system further comprises a reporting structure that allows for information to tracked and analyzed.

16. The educational system of claim 6 wherein said educational system further comprises a reporting structure that allows for information to tracked and analyzed.

17. The educational system of claim 7 wherein said educational system further comprises a reporting structure that allows for information to tracked and analyzed.

18. The educational system of claim 8 wherein said educational system further comprises a reporting structure that allows for information to tracked and analyzed.

19. The educational system of claim 9 wherein said educational system further comprises a reporting structure that allows for information to tracked and analyzed.

20. The educational system of claim 10 wherein said educational system further comprises a reporting structure that allows for information to tracked and analyzed.
